(19) United States
(12) Patent Application Publication
(10) Pub. No.: US 2003/0145044 A1
(43) Pub. Date: Jul. 31, 2003

(54) Virtual terminal for mobile network interface between mobile terminal and software applications node

(75) Inventors: Tommi Raivisto, Vantaa (FI); Patrik Gustafsson, Foster City, CA (US)

Correspondence Address: Ware, Fressola, Van Der Sluys & Adolphson, LLP, Building Five, Bradford Green, 755 Main Street, P.O. Box 224, Monroe, CT, 06468, US

(73) Assignee: Nokia Corporation, Espoo (FI)

(21) Appl. No.: 10/058,973

(22) Filed: Jan. 28, 2002

(51) Int. Cl. G06F 15/16

(52) U.S. Cl. 709/203; 709/229

(57) ABSTRACT

A method and apparatus are provided for sharing information about an end user of a mobile terminal with an applications node in a wireless network, in which a virtual terminal arranged between the mobile terminal to the applications node provides end user information about the end user of the mobile terminal to the applications node from a centralized point. The mobile terminal stores end user information and has a mobile terminal user interface for managing the provision of the end user information. The mobile terminal also stores end user rules or preferences controlling how different types of the end user information can be used and to whom the end user information can be given in the wireless network. The end user of the mobile terminal also requires manual confirmation so that the end user will be prompted each time certain end user information is requested by the applications node. The mobile terminal user interface manages these end user rules and preferences.

### BACKGROUND OF THE INVENTION

1. Field Of Invention

The present invention relates to a mobile network; and more particularly relates to a mobile network that provides developer friendly web service.

2. Description of Related Art

A mobile network, including a mobile terminal, has lots of information about its subscribers. Some of this information is static (e.g. name, sex, age) and some of this information is dynamic (e.g. location, availability). This information is very valuable and necessary for producing personal and attractive value added services.

Typically, an applications node in a mobile network has access to end user information by application specific mechanisms. Each application node has to maintain its own database and acquire information about end users in its own way. Information about an end user's mobile terminal may include its terminal capabilities, screen size, colors, number of keys, etc.

However, one problem in the prior art network is that the software applications node cannot access user specific data (user profile) in a generic way that is stored in the mobile network (including the mobile terminal).

Another problem in the prior art network is that the privacy of the end user (user profile) is not protected in a general manner and a mobile terminal has no effective control over the privacy parameters in the mobile network.

Another problem in the prior art network is that the provision of end user information to the software applications node is not exposed in the overall mobile network in a manner that is familiar in the IT domain.

Another problem in the prior art network is that the end user information is fragmented to several nodes in the network (including the terminal).

Other problems include: (1) the inability to get user data when the mobile terminal is unreachable, for instance off or out of coverage; (2) the need to prevent an end user from paying for data transmission; and (3) the need to prevent exposing a network address (such as MSISDN) or IP address of the mobile terminal.

### SUMMARY OF INVENTION

In its broadest sense, the present invention provides a new and unique method and apparatus for sharing information about an end user of a mobile terminal with an applications node in a mobile network, in which a virtual terminal arranged between the mobile terminal to the applications node provides information about the end user of the mobile terminal to the applications node.

In the present information, the mobile terminal may primarily store the end user information and has a mobile terminal user interface for managing the provision of the end user information. The mobile terminal may also store end user rules or preferences controlling how different types of the end user information can be used and to whom the end user information can be given in the wireless network. The end user of the mobile terminal can also require manual confirmation so that the end user will be prompted each time certain end user information is requested by the applications node. The mobile terminal user interface manages these end user rules and preferences.

Compliance with the end user rules and preferences regarding individual types of end user information may be optionally enforced using encryption or digital rights management (DRM) protocols.

Some types of end user information such as the location of the mobile terminal may originate in the network and be obtained with end user permission from the network, for instance, using a synchronization protocol such as SynchML.

A copy of the end user information, rules and preferences may also be stored in the virtual terminal which is located in a trusted server in the network. The data transfer between the mobile terminal and the virtual terminal is made using a management protocol handling commands, operations and data. A subset of this interface may include a synchronization protocol. Another subset of the interface may be handled using remote procedure calls.

The end user rules and preferences are taken into account in the synchronization process between the mobile terminal and the virtual terminal. Depending on the end user so-called “paranoia level”, the end user may determine that nothing is copied to the virtual terminal, so that all end user information is only stored in the mobile terminal and no end user information is given to the applications node without manual end user intervention.

The end user rules and preferences are also taken into account when passing the end user information to the applications node. This may also be accomplished using known cryptography and digital rights management (DRM) protocols to ensure privacy.

The virtual terminal may have a direct user interface, and may also provide user interface services in addition to services by WEB services interfaces. The virtual terminal may also act as a “service termination point” on behalf of the mobile terminal. That is purchase operations may be performed autonomously by the virtual terminal entity. A web service interface, including protocols such as Extensible Markup Language (XML), Web Services Description Language (WDSL), Simple Object Access Protocol (SOAP), Universal Description, Discovery and Integration (UDDI) and Hypertext Transfer Protocol; Hypertext Transport Protocol (HTTP), may also be used between the virtual terminal and the applications node.

The applications node is typically a software applications node and may exist outside the mobile network (e.g. in the WEB domain).

The present invention may preferably be implemented in the terminal and server products (brokers related to privacy, terminal management, presence, user profiles). In particular, the invention may be implemented in the mobile network (including terminals) as well as the “consumption part” of it can be implemented in typical IT middleware software such as application servers.

The present invention solves the problem of how the software applications node can access user specific data (user profile) without talking directly with the mobile terminal while protecting end user privacy.

Second, the invention solves the overall problem of how to provide the end user information from the mobile terminal to the applications node in a manner that protects end user privacy and provides level of control to the mobile terminal in the wireless network.

Third, the invention solves the problem of how the end user information can be seamlessly exposed to the software applications node in a manner that is familiar in the IT domain.

Fourth, the invention solves the problem of fragmented end user information by providing a centralized point for the applications node to access such information.

Features of the present invention may also be used to solves other problems such as (1) how to provide access to user data when the mobile terminal is off or out of coverage; (2) how to prevent the end user from paying for data transmission; and (3) how to prevent exposing the network address (such as MSISDN) of the mobile terminal.

### BRIEF DESCRIPTION OF THE DRAWING

The drawing, not drawn to scale, includes the following Figures:

FIG. 1 is a diagram of a wireless network having a virtual terminal interface between a mobile terminal and an applications node that forms the subject matter of the present invention.

FIG. 2 is a block diagram of the mobile terminal shown in FIG. 1.

FIG. 3 is a diagram of the virtual terminal shown in FIG. 1.

FIG. 4 is a diagram of the applications node shown in FIG. 1.

### DETAILED DESCRIPTION OF INVENTION

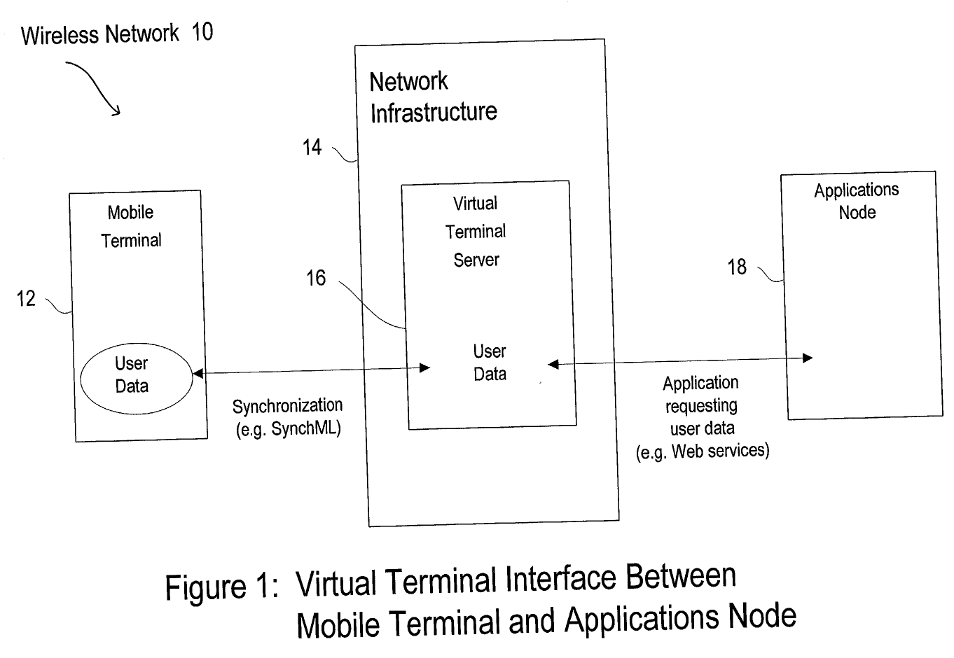

### FIG. 1: The Basic Invention

FIG. 1 shows a mobile network generally indicated as 10 having a mobile terminal 12, a network infrastructure 14, a virtual terminal node 16 and an applications node 18. The virtual terminal node 16 is shown in the form of a virtual terminal server 16. According to the present invention, the virtual terminal server 16 is arranged between the mobile terminal 12 to the applications node 18 and provides information about the end user of the mobile terminal 12 to the applications node 18.

In general, the applications node 18 will provide an applications node end user information request signal to the virtual terminal server 16 requesting end user information about the end user of the mobile terminal 12.

If the requested end user information is stored in the virtual terminal server 16 and accessible to the applications node 18 in relation to any end user rules and preferences controlling its distribution, then the virtual terminal server 16 may respond to this signal and provide a virtual terminal server signal containing the end user information to the applications node 18.

If the requested end user information is not stored in the virtual terminal server 16 or the end user preferences indicate that this information cannot be given without user intervention, then the virtual terminal server 16 may responds to this signal and provide a virtual terminal server end user information request signal to the mobile terminal 12 requesting the information. The mobile terminal 12 may respond to this signal and provide a mobile terminal signal containing the end user information (or a permission that it can be given to the applications node 18) back to the virtual terminal server 16. The virtual terminal server 16 may respond to this signal and provides the virtual terminal server signal containing the end user information to the applications node 18.

When the applications node 18 receives the virtual terminal server signal containing the end user information, it processes the information in a manner described below.

In FIG. 1, the virtual terminal server 16 is shown contained within the network infrastructure 14. The network infrastructure 14, other than the virtual terminal server 16, is known in the art, and the scope of the invention is not intended to be limited to any particular type or kind thereof. Many different networks and network infrastructures are envisioned that may contain the fundamental features of the virtual terminal server interface that is the subject matter of the present invention, including but not limited to mobile networks that are wireless or not.

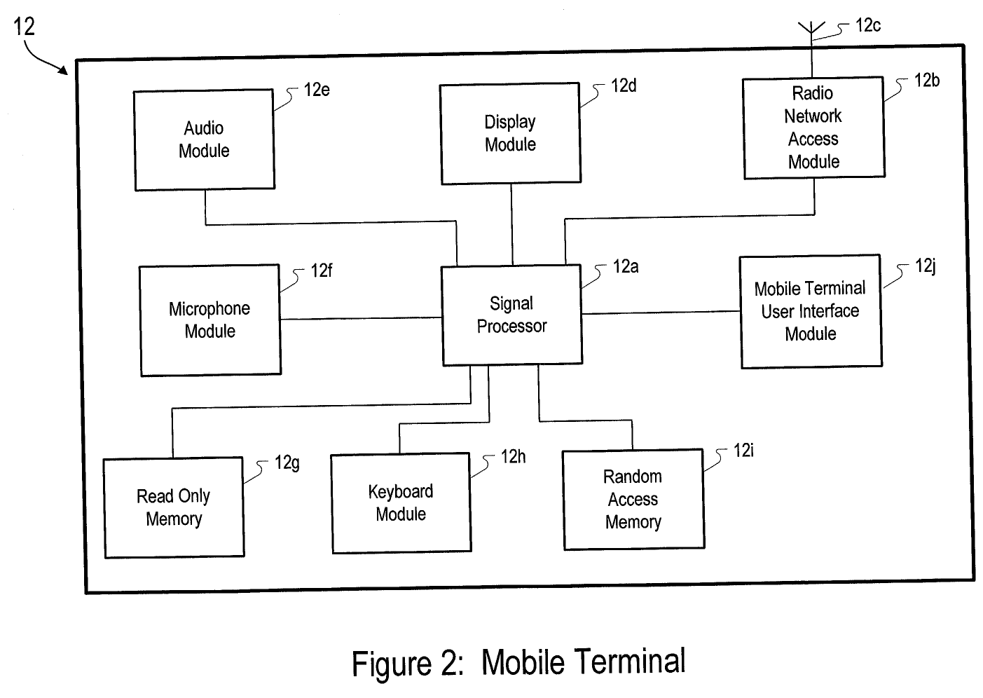

### FIG. 2: The Mobile Terminal 12

FIG. 2 shows a block diagram of the mobile terminal 12 shown in FIG. 1, and includes a signal processor 12a connected to a radio access network module 12b (connected to an antenna 12c), a display module 12d, an audio module 12e, a microphone 12f, a read only memory 12g (ROM or EPROM), a keyboard module 12h and a random access memory 12i (RAM). The signal processor 12a controls the operation of wireless terminal 12, the operation of which is known in the art. Moreover, the scope of the invention is not intended to be limited to any particular kind or type of the aforementioned elements 12a, 12b, . . . , 12i. For example, the scope of the invention is intended to include the radio access network module 12b being either an antenna module, a radio frequency (RF) module, a radio modem or the like. The wireless terminal 12 may also include many other circuit elements known in the art, which are not shown or described.

### The Mobile Terminal User Interface Module 12j

The wireless terminal 12 features a mobile terminal user interface module 12j for providing interface functions of the mobile terminal 12 in relation to the virtual terminal server 16 (FIG. 1), including managing the storage of the end user information in the mobile terminal 12; managing the storage and implementation of end user rules and preferences that govern the transfer of the end user information to the virtual terminal 16 (FIG. 1); managing the manual confirmation by, and prompting of, the end user in relation to the transfer of certain end user information requested by the virtual terminal 16; managing the use of encryption, digital rights management and synchronization of protocols governing the transfer of the end user information between the mobile terminal 12 and the virtual terminal 16; as well as controlling the transfer of the end user information between the mobile terminal 12 and the virtual terminal 16.

The mobile terminal user interface module 12j may be implemented using hardware, software, or a combination thereof. In a typical software implementation, the mobile terminal user interface module 12j would be a microprocessor-based architecture having a microprocessor, a random access memory (RAM), a read only memory (ROM), input/output devices and control, data and address buses connecting the same. A person skilled in the art of programming, especially programming of wireless terminals, would be able to program such a microprocessor-based implementation to perform the functionality described herein without undue experimentation.

The scope of the invention is not intended to be limited to any specific kind of mobile terminal or device, and many different mobile terminals or device are envisioned that may contain the fundamental features of the present invention described herein.

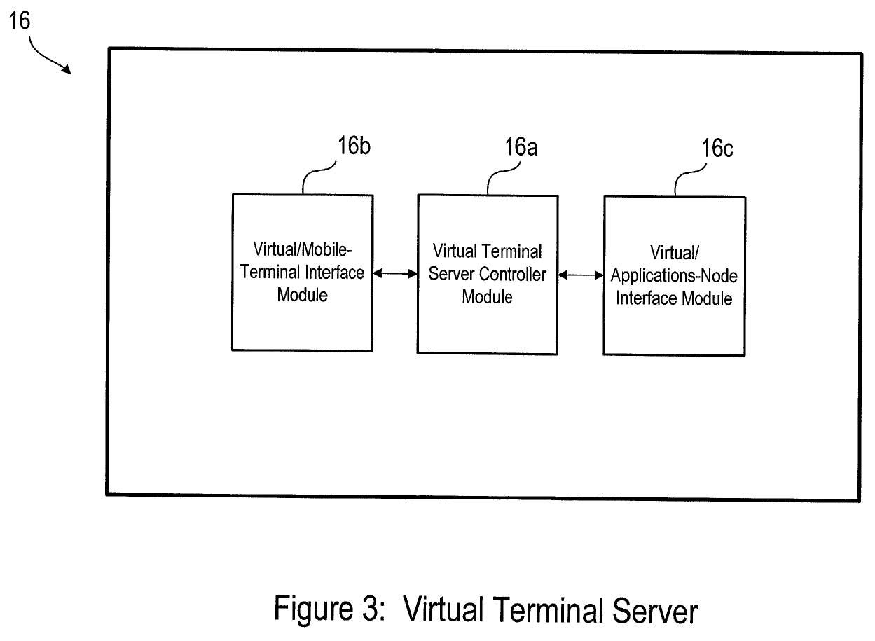

### FIG. 3: The Virtual Terminal Server 16

FIG. 3 shows a block diagram of the virtual terminal server 16 shown in FIG. 1, and includes a virtual terminal server controller module 16a connected to a virtual/mobile-terminal interface module 16b and a virtual/applications node interface module 16c. The virtual terminal server 16 is described herein as being implemented using a trusted server in the network infrastructure 14 (FIG. 1); however, the scope of the invention is not intended to be limited to only the same. Embodiments are envisioned in which the virtual terminal server is implemented as simply a virtual terminal using another type of architecture that is not necessarily server-based as that term is presently known in the art.

### The Virtual Terminal Server Controller Module 16a

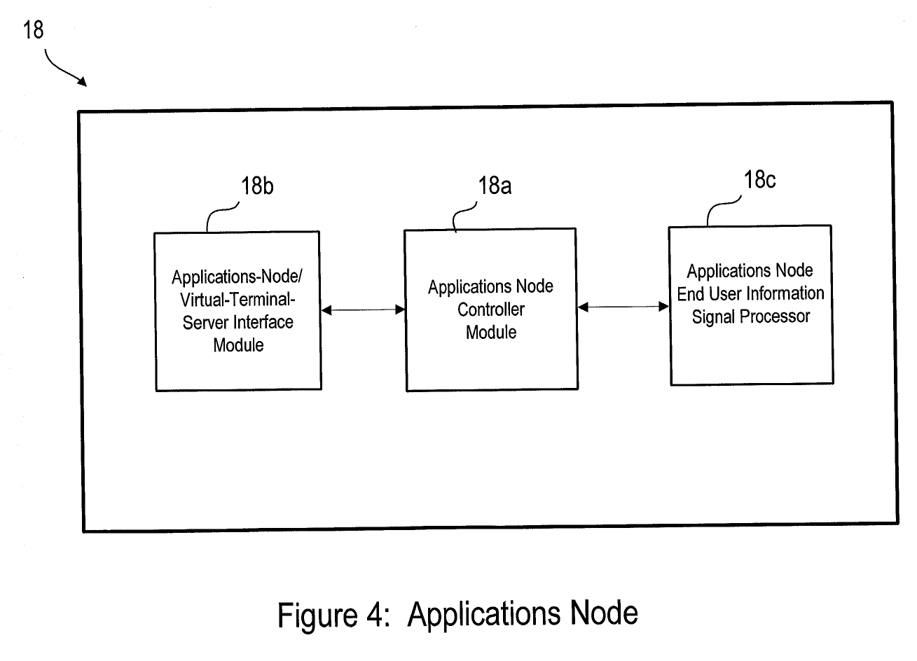

The virtual terminal server controller module 16a performs control functions that may include, but are not limited to, controlling the overall operation of the virtual terminal server 16, including controlling the interface function s between the virtual/mobile-terminal interface module 16b and the mobile terminal user interface module 12j (FIG. 2) of the mobile terminal 12 (FIG. 1), the management and storage of the end user information, rules and preferences of the end user information received from the mobile terminal 12, the management and storage of network originating information about the mobile terminal received from the network infrastructure 14, as well as the interface functions between the virtual/applications node interface module 16c and an applications-node/virtual-terminal-server interface module 18b shown in FIG. 4 of the applications node 18 (FIG. 1).

### The Virtual/Mobile-Terminal Interface Module 16b

The virtual/mobile-terminal interface module 16b performs interface functions that may include, but are not limited to, controlling the request for the end user information from the mobile terminal 12 (FIG. 1), the use of encryption, digital rights management and synchronization protocols during the transfer of the end user information from the mobile terminal 12, as well as controlling the receipt and provisioning of the end user information received from the mobile terminal 12.

### The Virtual/Applications Node Interface Module 16c

The virtual/applications node interface module 16c performs interface functions that may include, but are not limited to, managing the request of end user information from the applications node 18 (FIG. 1), the use of encryption, digital rights management and synchronization protocols during the transfer of the end user information to the applications node 18, as well as the transfer of the end user information to the applications node 18, including using a web service based protocol.

### FIG. 4: The Applications Node 18

FIG. 4 shows a block diagram of the applications node 18 shown in FIG. 1, and includes an applications node controller module 18a connected to an applications node/virtual-terminal-server interface module 18b and an applications node end user information signal processor 18c.

### The Applications Node Controller Module 18a

The applications node controller module 18a performs control function to operate the applications node 18 including, but not limited to, coordinating the operation of the applications-node/virtual-terminal-server interface module 18b and the applications node end user information signal processor 18c.

### The Applications-Node/Virtual-Terminal-Server Interface Module 18b

The applications-node/virtual-terminal-server interface module 18b performs the interface functions in relation to the virtual/applications-node interface module 16c (FIG. 3) of the virtual terminal server 16, that may include, but are not limited to, managing making the request for end user information from the virtual terminal server 16 (FIG. 1), managing the use of encryption, digital rights management and synchronization protocols during the transfer of the end user information from the virtual terminal 16 to the applications node 18, managing the receipt and storage of the end user information received from the virtual terminal server 16, controlling the transfer of the end user information from the virtual terminal 16, including using a web service based protocol, as well as the provisioning of the end user information received from the virtual terminal server 16 for processing by the applications node end user information signal processor 18c, or one or more other modules (not shown) in the applications node 18.

### The Applications Node End User Information Signal Processor 18c

The applications node end user information signal processor 18c processes the end user information in the applications node 18. The applications node 18 is described herein as a software applications node, although the scope of the invention is not intended to be limited to any particular type or kind thereof, or the manner in which any particular type or kind thereof uses or processes the end user information by the applications node end user information signal processor 18c.

### Implementation of Modules 16a, 16b, 16c, 18a, 18b, 18c

The virtual terminal server controller module 16a, the virtual/mobile-terminal interface module 16b, the virtual/applications node interface module 16c, the applications node controller module 18a, the applications-node/virtual-terminal-server interface module 18b and the applications node end user information signal processor 18c may be implemented using hardware, software, or a combination thereof. In a typical software implementation, these modules 16a, 16b, 16c, 18a, 18b, 18c would be a microprocessor-based architecture having a microprocessor, a random access memory (RAM), a read only memory (ROM), input/output devices and control, data and address buses connecting the same. A person skilled in the art of programming would be able to program such a microprocessor-based implementation to perform the functionality discussed herein without undue experimentation. The scope of the invention is not intended to be limited to the manner of implementation of these modules 16a, 16b, 16c, 18a, 18b, 18c.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

We claim:

1. A method for sharing information about an end user of a mobile terminal with an applications node in a network, including a mobile network, characterized in that a virtual terminal arranged between the mobile terminal to the applications node provides information about the end user of the mobile terminal to the applications node.

2. A method according to claim 1, characterized in that the mobile terminal stores end user information and has a mobile terminal user interface for managing the end user information.

3. A method according to claim 1, characterized in that the mobile terminal stores end user rules or preferences about how different types of the end user information are usable by the applications node.

4. A method according to claim 1, characterized in that the mobile terminal requires according to end user preferences manual confirmation, and the end user thereof is prompted by the virtual terminal each time certain end user information is requested by the applications node.

5. A method according to claim 3, characterized in that the mobile terminal has a mobile terminal user interface for managing the end user rules or preferences.

6. A method according to claim 5, characterized in that compliance with the end user rules and preferences regarding at least some end user information are enforced using encryption or digital rights management (DRM) protocols.

7. A method according to claim 1, characterized in that at least some end user information originates in a network infrastructure of the wireless network.

8. A method according to claim 7, characterized in that the at least some end user information is obtained from the network infrastructure using a synchronization protocol.

9. A method according to claim 1, characterized in that the virtual terminal stores a copy of at least some end user information, end user rules and preferences, or a combination thereof.

10. A method according to claim 1, characterized in that the virtual terminal is located in a trusted server in a network infrastructure of the wireless network.

11. A method according to claim 1, characterized in that data is transferred between the mobile terminal and the virtual terminal using a management protocol.

12. A method according to claim 1, characterized in that a synchronization protocol between the mobile terminal and the virtual terminal accounts for end user rules and preferences.

13. A method according to claim 1, characterized in that the virtual terminal stores end user information based on end user rules and preferences.

14. A method according to claim 1, characterized in that the virtual terminal provide s end user information in response to manual end user intervention requests, but does not store the end user information based on end user rules and preferences.

15. A method according to claim 1, characterized in that the virtual terminal accounts for end user preferences when providing the end user information to the applications node.

16. A method according to claim 1, characterized in that the virtual terminal uses cryptography and digital rights management (DRM) means when providing the end user information to the applications node.

17. A method according to claim 1, characterized in that an interface from the virtual terminal to the applications node is based on web service interface.

18. A network having a mobile terminal operated by an end user that shares information with an applications node characterized in that the network comprises:
an applications node for providing an applications node end user information request signal requesting information about the end user of the mobile terminal, and responding to a virtual terminal server signal containing end user information for processing the same;
a virtual terminal server, responsive to the applications node end user information request signal, for providing a virtual terminal server end user information request signal to the mobile terminal, and responsive to a mobile terminal signal containing the end user information, for providing the virtual terminal server signal containing the end user information to the applications node; and
a mobile terminal, responsive to the virtual terminal server end user information request signal, for providing the mobile terminal signal containing the end user information to the virtual terminal server.

19. A network according to claim 18, characterized in that the mobile terminal stores the end user information and has a mobile terminal user interface for managing the end user information.

20. A network according to claim 18, characterized in that the mobile terminal stores end user rules or preferences about how different types of the end user information are usable by the applications node.

21. A network according to claim 18, characterized in that the mobile terminal requires manual confirmation and the end user thereof is prompted by the virtual terminal server each time certain end user information is requested by the applications node.

22. A network according to claim 21, characterized in that the mobile terminal has a mobile terminal user interface for managing the end user rules or preferences.

23. A network according to claim 21, characterized in that compliance with the end user rules and preferences regarding at least some end user information are enforced using encryption or digital rights management (DRM) protocols.

24. A network according to claim 18 characterized in that at least some end user information originates in other network nodes, such as a network infrastructure, of the network.

25. A network according to claim 18, characterized in that the virtual terminal server obtains at least some end user information from the network infrastructure.

26. A network according to claim 18, characterized in that the virtual terminal server stores a copy of at least some end user information, end user rules and preferences, or a combination thereof.

27. A network according to claim 18, characterized in that the virtual terminal server is located in a trusted server in a network infrastructure of the wireless network.

28. A network according to claim 18, characterized in that data is transferred between the mobile terminal and the virtual terminal server using a management protocol.

29. A network according to claim 18, characterized in that a synchronization protocol between the mobile terminal and the virtual terminal server accounts for end user rules and preferences.

30. A network method according to claim 18, characterized in that the virtual terminal server stores end user information based on end user rules and preferences.

31. A network according to claim 18, characterized in that the virtual terminal provides the end user information in response to manual end user intervention requests, but does not store end user information based on end user rules and preferences.

32. A network according to claim 18, characterized in that the virtual terminal server accounts for end user preferences when providing the end user information to the applications node.

33. A network according to claim 18, characterized in that the virtual terminal server uses cryptography and digital rights management (DRM) means when providing the end user information to the applications node.

34. A network according to claim 18, characterized in that an interface from the virtual terminal server to the applications node is based on a web service interface.

35. A network according to claim 18, characterized in that the network is a wireless network.
